(19) United States
(12) Patent Application Publication
(10) Pub. No.: US 2023/0334724 A1
(43) Pub. Date: Oct. 19, 2023

(54) Transposing Virtual Objects Between Viewing Arrangements

(71) Applicant: Apple Inc., Cupertino, CA (US)

(72) Inventors: Jordan A. Cazamias, San Francisco, CA (US); Aaron M. Burns, Sunnyvale, CA (US); David M. Schattel, Santa Clara, CA (US); Jonathan Perron, Felton, CA (US); Jonathan Ravasz, Sunnyvale, CA (US); Shih-Sang Chiu, Menlo Park, CA (US)

(21) Appl. No.: 18/123,833

(22) Filed: Mar. 20, 2023

Related U.S. Application Data
(63) Continuation of application No. PCT/US21/47985, filed on Aug. 27, 2021.
(60) Provisional application No. 63/081,987, filed on Sep. 23, 2020.

(51) Int. Cl. G06T 11/00; G06F 3/16

(52) U.S. Cl. CPC G06T 11/00; G06F 3/16; G06T 2200/24

(57) ABSTRACT

Various implementations disclosed herein include devices, systems, and methods for determining a placement of virtual objects in a collection of virtual objects when changing from a first viewing arrangement to a second viewing arrangement based on their respective positions in one of the viewing arrangements. In some implementations, a method includes displaying a set of virtual objects in a first viewing arrangement in a first region of an environment. The set of virtual objects are arranged in a first spatial arrangement. A user input corresponding to a request to change to a second viewing arrangement in a second region of the environment is obtained. A mapping is determined between the first spatial arrangement and a second spatial arrangement based on spatial relationships between the set of virtual objects. The set of virtual objects is displayed in the second viewing arrangement in the second region of the environment.

### CROSS-REFERENCE TO RELATED APPLICATIONS

This application is a continuation of Intl. Patent App. No. PCT/US2021/47985, filed on Aug. 27, 2021, which claims priority to U.S. Provisional Patent App. No. 63/081,987, filed on Sep. 23, 2020, which are incorporated by reference in their entirety.

### TECHNICAL FIELD

The present disclosure generally relates to displaying virtual objects.

### BACKGROUND

Some devices are capable of generating and presenting graphical environments that include virtual objects and/or representations of physical elements. These environments may be presented on mobile communication devices.

### BRIEF DESCRIPTION OF THE DRAWINGS

So that the present disclosure can be understood by those of ordinary skill in the art, a more detailed description may be had by reference to aspects of some illustrative implementations, some of which are shown in the accompanying drawings.

FIGS. 1A-1D illustrate example operating environments according to some implementations.

FIG. 2 depicts an exemplary system for use in various computer enhanced technologies.

FIG. 3 is a block diagram of an example virtual object arranger according to some implementations.

FIGS. 4A-4C are flowchart representations of a method for determining a placement of virtual objects in a collection of virtual objects in accordance with some implementations.

FIG. 5 is a block diagram of a device in accordance with some implementations.

In accordance with common practice the various features illustrated in the drawings may not be drawn to scale. Accordingly, the dimensions of the various features may be arbitrarily expanded or reduced for clarity. In addition, some of the drawings may not depict all of the components of a given system, method, or device. Finally, like reference numerals may be used to denote like features throughout the specification and figures.

### SUMMARY

Various implementations disclosed herein include devices, systems, and methods for determining a placement of virtual objects in a collection of virtual objects when changing from a first viewing arrangement to a second viewing arrangement based on their respective positions in one of the viewing arrangements. In some implementations, a method includes displaying a set of virtual objects in a first viewing arrangement in a first region of an extended reality (XR) environment that is bounded. The set of virtual objects are arranged in a first spatial arrangement. A user input corresponding to a request to change to a second viewing arrangement in a second region of the XR environment is obtained. A mapping is determined between the first spatial arrangement and a second spatial arrangement based on spatial relationships between the set of virtual objects. The set of virtual objects is displayed in the second viewing arrangement in the second region of the XR environment that is unbounded.

In accordance with some implementations, a device includes one or more processors, a non-transitory memory, and one or more programs. In some implementations, the one or more programs are stored in the non-transitory memory and are executed by the one or more processors. In some implementations, the one or more programs include instructions for performing or causing performance of any of the methods described herein. In accordance with some implementations, a non-transitory computer readable storage medium has stored therein instructions that, when executed by one or more processors of a device, cause the device to perform or cause performance of any of the methods described herein. In accordance with some implementations, a device includes one or more processors, a non-transitory memory, and means for performing or causing performance of any of the methods described herein.

### DESCRIPTION

Numerous details are described in order to provide a thorough understanding of the example implementations shown in the drawings. However, the drawings merely show some example aspects of the present disclosure and are therefore not to be considered limiting. Those of ordinary skill in the art will appreciate that other effective aspects and/or variants do not include all of the specific details described herein. Moreover, well-known systems, methods, components, devices, and circuits have not been described in exhaustive detail so as not to obscure more pertinent aspects of the example implementations described herein.

A person can interact with and/or sense a physical environment or physical world without the aid of an electronic device. A physical environment can include physical features, such as a physical object or surface. An example of a physical environment is physical forest that includes physical plants and animals. A person can directly sense and/or interact with a physical environment through various means, such as hearing, sight, taste, touch, and smell. In contrast, a person can use an electronic device to interact with and/or sense an extended reality (XR) environment that is wholly or partially simulated. The XR environment can include mixed reality (MR) content, augmented reality (AR) content, virtual reality (VR) content, and/or the like. With an XR system, some of a person's physical motions, or representations thereof, can be tracked and, in response, characteristics of virtual objects simulated in the XR environment can be adjusted in a manner that complies with at least one law of physics. For instance, the XR system can detect the movement of a user's head and adjust graphical content and auditory content presented to the user similar to how such views and sounds would change in a physical environment. In another example, the XR system can detect movement of an electronic device that presents the XR environment (e.g., a mobile phone, tablet, laptop, or the like) and adjust graphical content and auditory content presented to the user similar to how such views and sounds would change in a physical environment. In some situations, the XR system can adjust characteristic(s) of graphical content in response to other inputs, such as a representation of a physical motion (e.g., a vocal command).

Many different types of electronic systems can enable a user to interact with and/or sense an XR environment. A non-exclusive list of examples include heads-up displays (HUDs), head mountable systems, projection-based systems, windows or vehicle windshields having integrated display capability, displays formed as lenses to be placed on users' eyes (e.g., contact lenses), headphones/earphones, input systems with or without haptic feedback (e.g., wearable or handheld controllers), speaker arrays, smartphones, tablets, and desktop/laptop computers. A head mountable system can have one or more speaker(s) and an opaque display. Other head mountable systems can be configured to accept an opaque external display (e.g., a smartphone). The head mountable system can include one or more image sensors to capture images/video of the physical environment and/or one or more microphones to capture audio of the physical environment. A head mountable system may have a transparent or translucent display, rather than an opaque display. The transparent or translucent display can have a medium through which light is directed to a user's eyes. The display may utilize various display technologies, such as uLEDs, OLEDs, LEDs, liquid crystal on silicon, laser scanning light source, digital light projection, or combinations thereof. An optical waveguide, an optical reflector, a hologram medium, an optical combiner, combinations thereof, or other similar technologies can be used for the medium. In some implementations, the transparent or translucent display can be selectively controlled to become opaque. Projection-based systems can utilize retinal projection technology that projects images onto users' retinas. Projection systems can also project virtual objects into the physical environment (e.g., as a hologram or onto a physical surface).

The present disclosure provides methods, systems, and/or devices for determining a placement of virtual objects in a collection of virtual objects when changing from a first viewing arrangement to a second viewing arrangement based on their respective positions in one of the viewing arrangements.

In various implementations, an electronic device, such as a smartphone, tablet, or laptop or desktop computer, displays virtual objects in an extended reality (XR) environment. The virtual objects may be organized in collections. Collections can be viewed in various viewing arrangements. One such viewing arrangement presents the virtual objects on two-dimensional virtual surfaces. Another viewing arrangement presents the virtual objects on a region of the XR environment that may be associated with a physical element. Requiring a user to arrange the virtual objects in each viewing arrangement may increase the amount of effort the user expends to organize and view the virtual objects. Interpreting and acting upon user inputs that correspond to the user manually arranging the virtual objects results in power consumption and/or heat generation, thereby adversely impacting operability of the device.

In various implementations, when a user changes a collection of virtual objects from a first viewing arrangement to a second viewing arrangement, the electronic device arranges the virtual objects in the second viewing arrangement based on their arrangement in the first viewing arrangement. For example, virtual objects that are clustered in the first viewing arrangement may be clustered in the second viewing arrangement. Automatically arranging the virtual objects in the second viewing arrangement reduces a need for user inputs corresponding to the user manually arranging the virtual objects in the second viewing arrangement. Reducing unnecessary user inputs reduces utilization of computing resources associated with interpreting and acting upon unnecessary user inputs, thereby enhancing operability of the device by reducing power consumption and/or heat generation by the device.

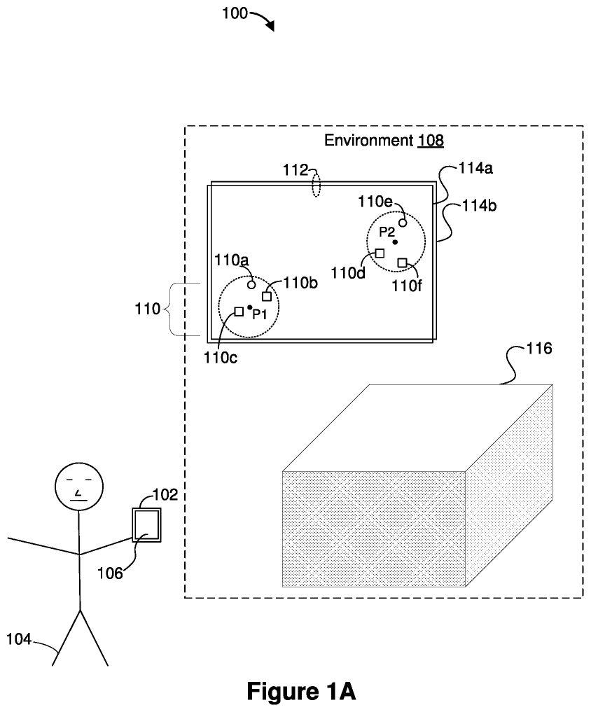

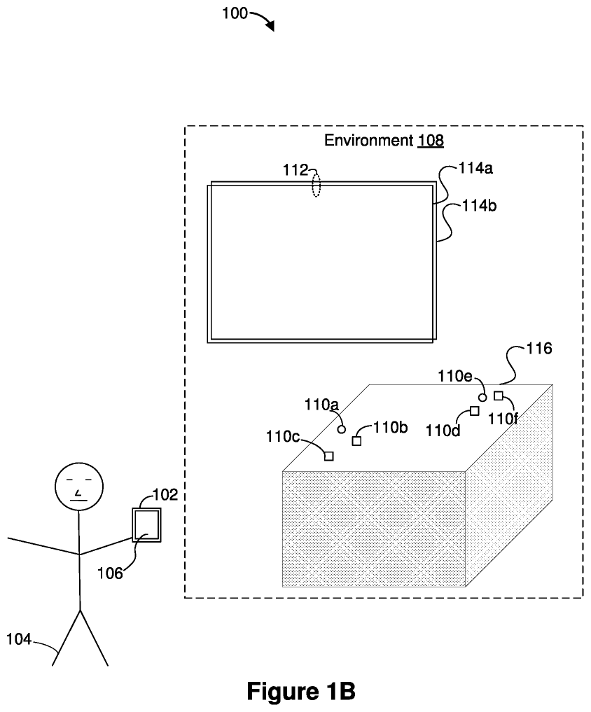

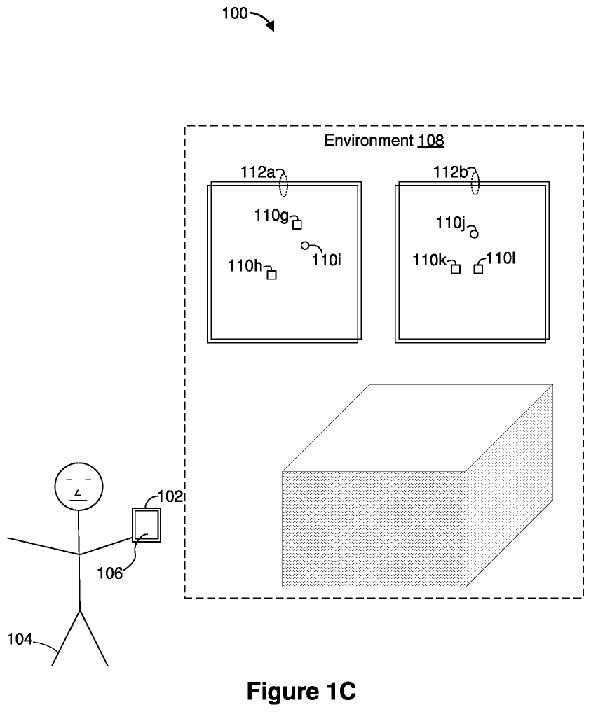

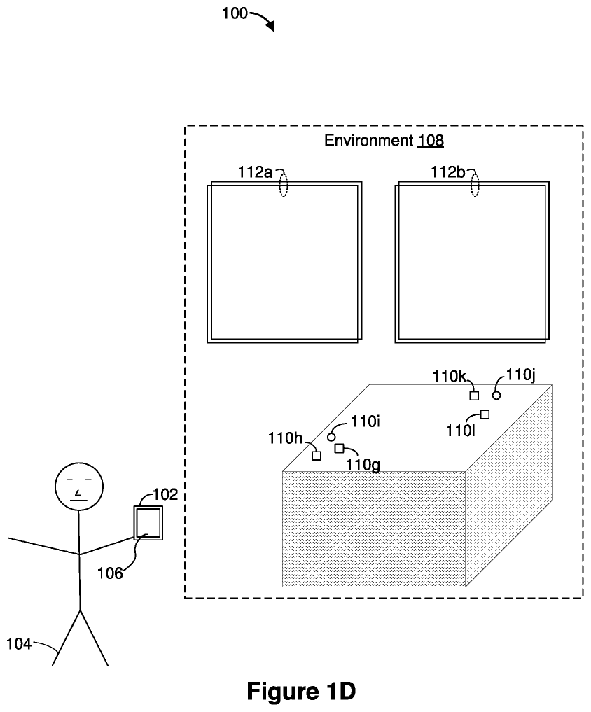

FIG. 1A is a diagram of an example operating environment 100 in accordance with some implementations. While pertinent features are shown, those of ordinary skill in the art will appreciate from the present disclosure that various other features have not been illustrated for the sake of brevity and so as not to obscure more pertinent aspects of the example implementations disclosed herein. To that end, as a non-limiting example, the operating environment 100 includes an electronic device 102 and a user 104.

In some implementations, the electronic device 102 includes a handheld computing device that can be held by the user 104. For example, in some implementations, the electronic device 102 includes a smartphone, a tablet, a media player, a laptop, or the like. In some implementations, the electronic device 102 includes a desktop computer. In some implementations, the electronic device 102 includes a wearable computing device that can be worn by the user 104. For example, in some implementations, the electronic device 102 includes a head-mountable device (HMD), an electronic watch or a pair of headphones. In some implementations, the electronic device 102 is a dedicated virtual assistant device that includes a speaker for playing audio and a microphone for receiving verbal commands. In some implementations, the electronic device 102 includes a television or a set-top box that outputs video data to a television.

In various implementations, the electronic device 102 includes (e.g., implements) a user interface engine that displays a user interface on a display 106. In some implementations, the display 106 is integrated in the electronic device 102. In some implementations, the display 106 is implemented as a separate device from the electronic device 102. For example, the display 106 may be implemented as an HMD that is in communication with the electronic device 102.

In some implementations, the user interface engine displays the user interface in an extended reality (XR) environment 108 on the display 106. The user interface may include one or more virtual objects 110a, 110b, 110c, 110d, 110e, 110f (collectively referred to as virtual objects 110) that are displayed in a first viewing arrangement in a region 112 of the XR environment 108. In some implementations, the first viewing arrangement is a bounded viewing arrangement. For example, the region 112 may include a two-dimensional virtual surface 114a enclosed by a boundary and a two-dimensional virtual surface 114b that is substantially parallel to the two-dimensional virtual surface 114a. The virtual objects 110 may be displayed on either of the two-dimensional virtual surfaces 114a, 114b. In some implementations, the virtual objects 110 may be displayed between the two-dimensional virtual surfaces 114a, 114b.

As shown in FIG. 1A, the virtual objects 110a, 110b, and 110c may share a first spatial characteristic, e.g., being within a threshold radius of a point P1. The virtual objects 110d, 110e, and 110f may share a second spatial characteristic, e.g., being within a threshold radius of a point P2. In some implementations, the first spatial characteristic and/or the second spatial characteristic are related to functional characteristics of the virtual objects 110. For example, the virtual objects 110a, 110b, and 110c may be associated with a first application, and the virtual objects 110d, 110e, and 110f may be associated with a second application. In some implementations, the first spatial characteristic and/or the second spatial characteristic are determined by user placement of the virtual objects 110.

In some implementations, the electronic device 102 obtains a user input corresponding to a change to a second viewing arrangement in a region 116 of the XR environment 108. The second viewing arrangement may be an unbounded viewing arrangement. For example, the region 116 may be associated with a physical element in the XR environment 108. In some implementations, the user input is a gesture input. For example, the electronic device 102 may detect a gesture directed to one or more of the virtual objects or to the region 112 and/or the region 116. In some implementations, the user input is an audio input. For example, the electronic device 102 may detect a voice command to change to the second viewing arrangement. In some implementations, the electronic device 102 may receive the user input from a user input device, such as a keyboard, mouse, stylus, and/or touch-sensitive display. In some implementations, the electronic device 102 obtains a confirmation input to confirm that the user 104 wishes to change to the second viewing arrangement. For example, the electronic device 102 may sense a head pose of the user 104 or a gesture performed by the user 104.

In some implementations, the electronic device 102 determines a mapping between the first spatial arrangement and a second spatial arrangement. The mapping may be based on spatial relationships between the virtual objects 110. For example, virtual objects that share a first spatial characteristic, such as the virtual objects 110a, 110b, and 110c, may be grouped together and separately from virtual objects that share a second spatial characteristic, such as the virtual objects 110d, 110e, and 110f.

Referring to FIG. 1B, in some implementations, the electronic device 102 displays the set of virtual objects 110 in the second viewing arrangement in the region 116 of the XR environment 108. As shown in FIG. 1B, spatial relationships between the virtual objects 110 may be preserved. For example, the virtual objects 110a, 110b, and 110c may be displayed in a cluster because they share a spatial characteristic when displayed in the first spatial arrangement in the region 112. Similarly, the virtual objects 110d, 110e, and 110f may be displayed in a cluster because they share a spatial characteristic when displayed in the first spatial arrangement. Within each cluster, the spatial relationships between the virtual objects 110 may be preserved or changed. For example, while the virtual objects 110a, 110b, and 110c may be displayed in similar positions relative to one another in the second spatial arrangement, the virtual objects 110d, 110e, and 110f may be rearranged relative to one another in the second spatial arrangement.

Referring to FIG. 1C, in some implementations, the virtual objects 110 may share a spatial characteristic, such as being associated with a particular region in the XR environment 108. For example, the XR environment 108 may include multiple regions 112a, 112b. Each region 112a, 112b may include multiple two-dimensional virtual surfaces enclosed by respective boundaries. The virtual objects 110 may be displayed on any of the two-dimensional virtual surfaces. In some implementations, the virtual objects 110 may be displayed between the two-dimensional virtual surfaces.

In some implementations, the regions 112a, 112b are associated with different characteristics of the virtual objects 110. For example, the virtual objects 110g, 110h, 110i may be displayed in the region 112a because they are associated with a first application. As another example, the virtual objects 110g, 110h, 110i may represent content of a first media type. The virtual objects 110j, 110k, 110l may be displayed in the region 112b because they are associated with a second application and/or because they represent content of a second media type.

Referring to FIG. 1D, in some implementations, the electronic device 102 displays the set of virtual objects 110 in the second viewing arrangement in the region 116 of the XR environment 108. As shown in FIG. 1D, spatial relationships between the virtual objects 110 may be preserved. For example, the virtual objects 110g, 110h, and 110i may be displayed in a cluster because they share a spatial characteristic (e.g., association with the region 112a) when displayed in the first spatial arrangement in the region 112a. Similarly, the virtual objects 110j, 110k, and 110l may be displayed in a cluster because they share a spatial characteristic (e.g., association with the region 112b) when displayed in the first spatial arrangement.

In some implementations, a visual characteristic of one or more of the virtual objects 110 may be modified based on the viewing arrangement. For example, when a virtual object 110 is displayed in the first viewing arrangement, it may have a two-dimensional appearance. When the same virtual object 110 is displayed in the second viewing arrangement, it may have a three-dimensional appearance.

The user 104 may manipulate the virtual objects 110 in the second viewing arrangement. For example, the user 104 may use gestures and/or other inputs to move one or more of the virtual objects 110 in the second viewing arrangement. The user 104 may use a user input, such as a gesture input, an audio input, or a user input provided via a user input device, such as a keyboard, mouse, stylus, and/or touch-sensitive display, to return to the first viewing arrangement. In some implementations, when the virtual objects 110 are displayed in the first viewing arrangement, any virtual objects 110 that were moved in the second viewing arrangement are displayed in different positions (e.g., relative to their original positions) in the first viewing arrangement. In some implementations, when the virtual objects 110 are displayed in the first viewing arrangement, any virtual objects 110 that were not moved in the second viewing arrangement are displayed in their original positions (e.g., before changing to the second viewing arrangement) in the first viewing arrangement.

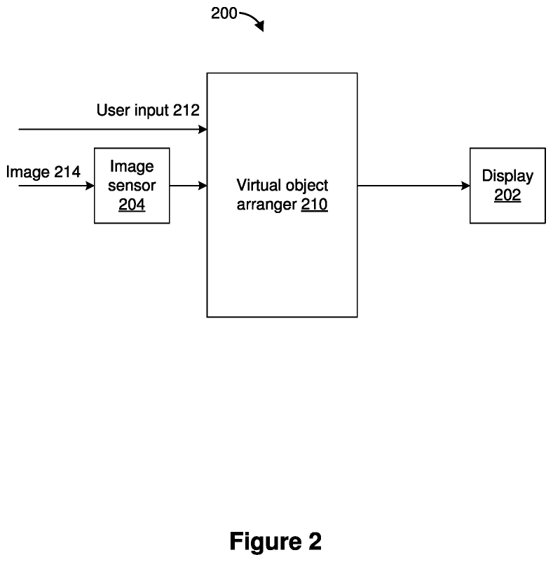

FIG. 2 is a block diagram of an example user interface engine 200. In some implementations, the user interface engine 200 resides at (e.g., is implemented by) the electronic device 102 shown in FIGS. 1A-1D. In various implementations, the user interface engine 200 determines a placement of virtual objects in a collection of virtual objects when changing from a first viewing arrangement to a second viewing arrangement based on their respective positions in one of the viewing arrangements. The user interface engine 200 may include a display 202, one or more processors, one or more image sensor(s) 204, and/or other input or control device(s).

In some implementations, the user interface engine 200 includes a display 202. The display 202 displays a set of virtual objects in a first viewing arrangement in a first region of an extended reality (XR) environment, such as the XR environment 108 of FIGS. 1A-1D. The first viewing arrangement may be a bounded viewing arrangement, such as the region 112 of FIG. 1A or the regions 112a, 112b of FIG. 1C. For example, the bounded viewing arrangement may include one or more sets of substantially parallel two-dimensional virtual surfaces that are enclosed by respective boundaries.

In the first viewing arrangement, the virtual objects are arranged in a first spatial arrangement. For example, the virtual objects may be displayed on any of the two-dimensional virtual surfaces. In some implementations, the virtual objects may be displayed between the two-dimensional virtual surfaces. Placement of the virtual objects may be determined by a user. In some implementations, placement of the virtual objects is determined programmatically, e.g., based on functional characteristics of the virtual objects. For example, placement of the virtual objects may be based on respective applications with which the virtual objects are associated. In some implementations, placement of the virtual objects is based on media types or file types of content with which the virtual objects are associated.

In some implementations, the virtual objects are displayed in groupings. For example, some virtual objects may share a first spatial characteristic of being within a threshold radius of a point. In some implementations, some virtual objects share a first spatial characteristic of being associated with a particular two-dimensional virtual surface or a particular space between two-dimensional virtual surfaces.

In some implementations, the user interface engine 200 obtains a user input 212 corresponding to a change to a second viewing arrangement in a second region of the XR environment. For example, the user interface engine 200 may receive the user input 212 from a user input device, such as a keyboard, mouse, stylus, and/or touch-sensitive display. In some implementations, the user input 212 includes an audio input received from an audio sensor, such as a microphone. For example, the user may provide a spoken command to change to the second viewing arrangement.

In some implementations, the user input 212 includes an image 214 received from the image sensor 204. The image 214 may be a still image or a video feed comprising a series of image frames. The image 214 may include a set of pixels representing an extremity of the user. The virtual object arranger 210 may perform image analysis on the image 214 to detect a gesture. For example, the virtual object arranger 210 may detect a gesture directed to one or more of the virtual objects or to a region in the XR environment.

In some implementations, the user input 212 includes a gaze vector received from a user-facing camera. For example, the virtual object arranger 210 may determine that a gaze of the user is directed to one or more of the virtual objects or to a region in the XR environment.

In some implementations, the virtual object arranger 210 obtains a confirmation input to confirm that the user wishes to change to the second viewing arrangement. For example, the virtual object arranger 210 may sense a head pose of the user or a gesture performed by the user. In some implementations, the confirmation input comprises a gaze vector that is maintained for at least a threshold duration.

In some implementations, the second viewing arrangement is an unbounded viewing arrangement. For example, in the second viewing arrangement, the virtual objects may be displayed in a region that is associated with a physical element in the XR environment. In the second viewing arrangement, the virtual objects are displayed in a second spatial arrangement. For example, some of the virtual objects may be displayed in clusters in the second spatial arrangement. The virtual object arranger 210 determines a mapping between the first spatial arrangement and the second spatial arrangement based on spatial relationships between the virtual objects. For example, virtual objects that share a first spatial characteristic may be grouped together and separately from virtual objects that share a second spatial characteristic. In some implementations, for example, virtual objects that are associated with a particular two-dimensional virtual surface in the first viewing arrangement may be displayed in a cluster in the second viewing arrangement.

In some implementations, the virtual object arranger 210 displays the set of virtual objects in the second viewing arrangement in the second region of the XR environment on the display 202. Spatial relationships between virtual objects may be preserved. For example, some virtual objects may be displayed in a cluster because they share a spatial characteristic when displayed in the first spatial arrangement in the first region of the XR environment. Within each cluster, the spatial relationships between the virtual objects may be preserved or changed.

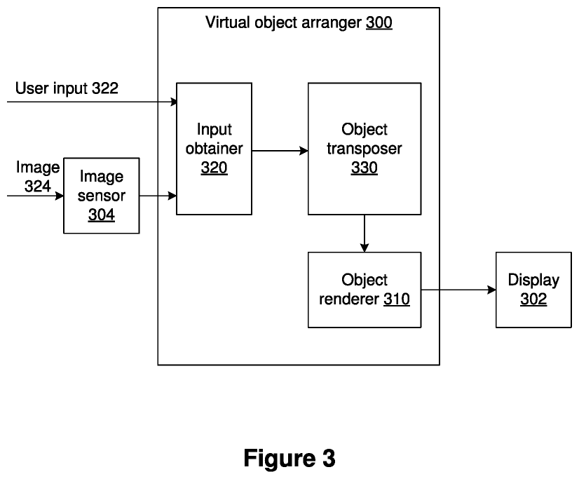

FIG. 3 is a block diagram of an example virtual object arranger 300 according to some implementations. In various implementations, the virtual object arranger 300 obtains a user input corresponding to a change from a first viewing arrangement to a second viewing arrangement of virtual objects in an extended reality (XR) environment, determines a mapping between a first spatial arrangement and a second spatial arrangement of the virtual objects, and displays the virtual objects in the second viewing arrangement.

In some implementations, the virtual object arranger 300 implements the virtual object arranger 210 shown in FIG. 2. In some implementations, the virtual object arranger 300 resides at (e.g., is implemented by) the electronic device 102 shown in FIGS. 1A-1D. The virtual object arranger 300 may include a display 302, one or more processors, one or more image sensor(s) 304, and/or other input or control device(s).

While pertinent features are illustrated, those of ordinary skill in the art will appreciate from the present disclosure that various other features have not been illustrated for the sake of brevity and so as not to obscure more pertinent aspects of the implementations disclosed herein. Those of ordinary skill in the art will also appreciate from the present disclosure that the functions and sub-functions implemented by the virtual object arranger 300 can be combined into one or more systems and/or further sub-divided into additional subsystems; and that the functionality described below is provided as merely one example configuration of the various aspects and functions described herein.

In some implementations, an object renderer 310 displays a set of virtual objects in a first viewing arrangement on the display 302 in a first region of an XR environment. The first viewing arrangement may be a bounded viewing arrangement and may include one or more sets of substantially parallel two-dimensional virtual surfaces that are enclosed by respective boundaries, such as the region 112 of FIG. 1A or the regions 112a, 112b of FIG. 1C. In some implementations, the virtual objects are arranged in a first spatial arrangement when they are displayed in the first viewing arrangement. For example, the virtual objects may be displayed on any of the two-dimensional virtual surfaces. In some implementations, the virtual objects may be displayed between the two-dimensional virtual surfaces. A user may place the virtual objects on or between the two-dimensional virtual surfaces, for example, using gesture inputs. In some implementations, placement of the virtual objects is determined programmatically. For example, the object renderer 310 may select a placement location for a virtual object based on an application with which the virtual object is associated and/or based on a media type or file type of content with which the virtual object is associated.

In some implementations, the object renderer 310 displays the virtual objects in groupings sharing spatial characteristics. For example, some virtual objects may share a spatial characteristic of being within a threshold radius of a point. In some implementations, some virtual objects share a spatial characteristic of being associated with a particular two-dimensional virtual surface or a particular space between two-dimensional virtual surfaces.

In some implementations, an input obtainer 320 obtains a user input 322 that corresponds to a change to a second viewing arrangement in a second region of the XR environment. For example, the input obtainer 320 may receive the user input 322 from a user input device, such as a keyboard, mouse, stylus, and/or touch-sensitive display. In some implementations, the user input 322 includes an audio input received from an audio sensor, such as a microphone. For example, the user may provide a spoken command to change to the second viewing arrangement.

In some implementations, the user input 322 includes an image 324 received from the image sensor 304. The image 324 may be a still image or a video feed comprising a series of image frames. The image 324 may include a set of pixels representing an extremity of the user. The input obtainer 320 may perform image analysis on the image 324 to detect a gesture. For example, the input obtainer 320 may detect a gesture directed to one or more of the virtual objects or to a region in the XR environment.

In some implementations, the user input 322 includes a gaze vector received from a user-facing image sensor. For example, the input obtainer 320 may determine that a gaze of the user is directed to one or more of the virtual objects or to a region in the XR environment.

In some implementations, the input obtainer 320 obtains a confirmation input to confirm that the user wishes to change to the second viewing arrangement. For example, the input obtainer 320 may use an accelerometer, gyroscope, and/or inertial measurement unit (IMU) to sense a head pose of the user. The input obtainer 320 may use the image sensor 304 to detect a gesture performed by the user. In some implementations, the confirmation input comprises a gaze vector that is maintained for at least a threshold duration.

In some implementations, the second viewing arrangement is an unbounded viewing arrangement in which the virtual objects are displayed in a region that may not be defined by a boundary. For example, in the second viewing arrangement, the virtual objects may be displayed in a region that is associated with a physical element in the XR environment. In the second viewing arrangement, the virtual objects are displayed in a second spatial arrangement. For example, some virtual objects may be displayed in clusters.

In some implementations, an object transposer 330 determines a mapping between the first spatial arrangement and the second spatial arrangement based on spatial relationships between the virtual objects. For example, virtual objects that share a first spatial characteristic may be grouped together. The virtual objects sharing the first spatial characteristic may be grouped separately from virtual objects that share a second spatial characteristic. For example, virtual objects that are associated with a first two-dimensional virtual surface in the first viewing arrangement may be displayed in a first cluster in the second viewing arrangement. Virtual objects that are associated with a second two-dimensional virtual surface in the first viewing arrangement may be displayed in a second cluster in the second viewing arrangement. The object transposer 330 may determine the distance between the first and second clusters based on, for example, the spatial relationship between the first and second two-dimensional virtual surfaces in the first viewing arrangement.

In some implementations, the object renderer 310 displays the set of virtual objects in the second viewing arrangement in the second region of the XR environment on the display 302. Spatial relationships between virtual objects may be preserved. For example, some virtual objects may be displayed in a cluster because they share a spatial characteristic when displayed in the first spatial arrangement in the first region of the XR environment. Within each cluster, the spatial relationships between the virtual objects may be preserved or changed. For example, the object transposer 330 may preserve the spatial relationships between the virtual objects to the extent possible while still displaying the virtual objects in the second region. In some implementations, the object transposer 330 arranges virtual objects to satisfy aesthetic criteria. For example, the object transposer 330 may arrange the virtual objects by shape and/or size. As another example, if the second region is associated with a physical element, the object transposer 330 may arrange the virtual objects based on the shape of the physical element.

In some implementations, the object renderer 310 resizes virtual objects to accommodate display constraints. For example, if the second region is associated with a physical element, the object renderer 310 may resize virtual objects to fit the physical element. In some implementations, the object renderer 310 resizes virtual objects to satisfy aesthetic criteria. For example, certain virtual objects may be resized to maintain proportionality with other virtual objects or with other features of the XR environment.

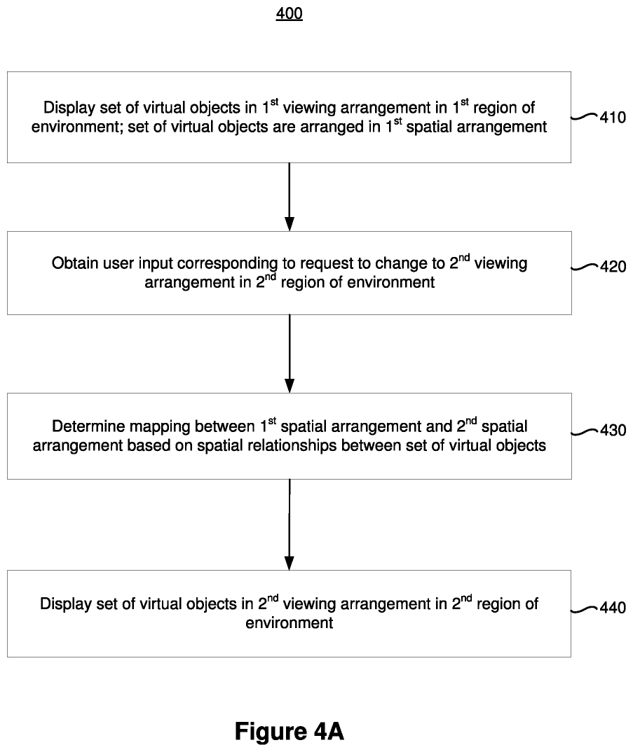

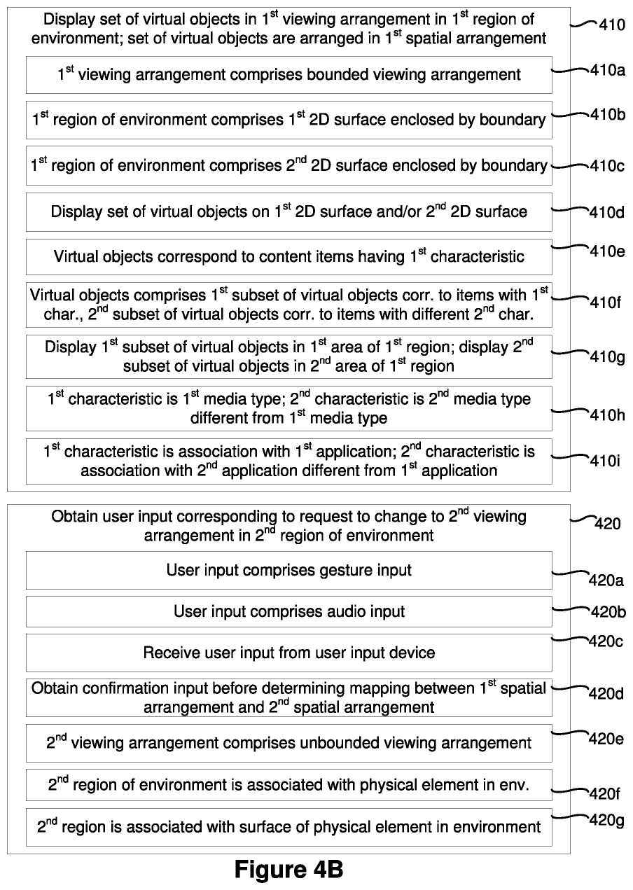

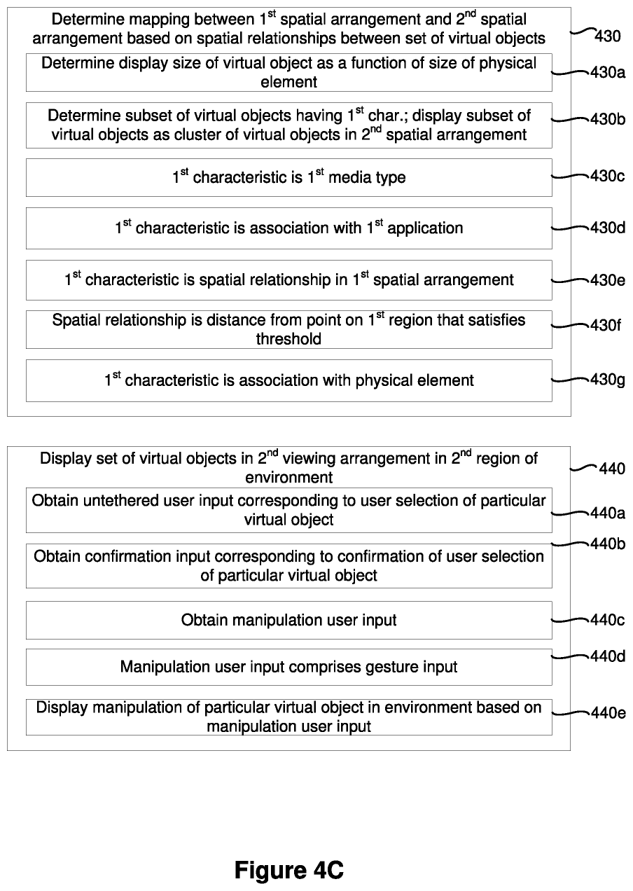

FIGS. 4A-4C are a flowchart representation of a method 400 for determining a placement of virtual objects in a collection of virtual objects when changing from a first viewing arrangement to a second viewing arrangement based on their respective positions in one of the viewing arrangements in accordance with some implementations. In various implementations, the method 400 is performed by a device (e.g., the electronic device 102 shown in FIGS. 1A-1D). In some implementations, the method 400 is performed by processing logic, including hardware, firmware, software, or a combination thereof. In some implementations, the method 400 is performed by a processor executing code stored in a non-transitory computer-readable medium (e.g., a memory). Briefly, in various implementations, the method 400 includes displaying a set of virtual objects in a first viewing arrangement in a first region of an XR environment. The virtual objects are arranged in a first spatial arrangement. The method 400 includes obtaining a user input corresponding to a change to a second viewing arrangement in a second region of the XR environment and determining a mapping between the first spatial arrangement and a second spatial arrangement based on spatial relationships between the virtual objects. The set of virtual objects are displayed in the second viewing arrangement in the second region of the XR environment.

Referring to FIG. 4A, as represented by block 410, in various implementations, the method 400 includes displaying a set of virtual objects in a first viewing arrangement in a first region of an XR environment that is bounded (e.g., surrounded by and/or enclosed within a visible boundary). The set of virtual objects are arranged in a first spatial arrangement. Referring to FIG. 4B, as represented by block 410a, the first viewing arrangement may be a bounded viewing arrangement. In some implementations, as represented by block 410b, the first region of the XR environment includes a first two-dimensional virtual surface, such as the two-dimensional virtual surface 114a, enclosed by a boundary. In some implementations, as represented by block 410c, the first region of the XR environment also includes a second two-dimensional virtual surface, such as the two-dimensional virtual surface 114b. The second two-dimensional virtual surface may be substantially parallel to the first two-dimensional virtual surface.

In some implementations, as represented by block 410d, the method 400 includes displaying the set of virtual objects on at least one of the first two-dimensional virtual surface or the second two-dimensional virtual surface. The virtual objects may be displayed between the two-dimensional virtual surfaces. In some implementations, a user assigns respective placement locations for the virtual objects on or between the two-dimensional virtual surfaces, for example, using gesture inputs.

In some implementations, respective placement locations for the virtual objects are assigned programmatically. For example, in some implementations, as represented by block 410e, the set of virtual objects correspond to content items that have a first characteristic. In some implementations, as represented by block 410f, the set of virtual objects include a first subset of virtual objects that correspond to content items that have a first characteristic and a second subset of virtual objects that correspond to content items that have a second characteristic that is different from the first characteristic. As represented by block 410g, the first subset of virtual objects may be displayed in a first area of the first region, and the second subset of virtual objects may be displayed in a second area of the first region. For example, as illustrated in FIG. 1A, the virtual objects 110a, 110b, and 110c are displayed in one area of region 112, and the virtual objects 110d, 110e, and 110f are displayed in another area of region 112. As another example, as illustrated in FIG. 1C, the virtual objects 110g, 110h, and 110i are displayed in region 112a, and the virtual objects 110j, 110k, and 110l are displayed in region 112b. In some implementations, as represented by block 410h, the first characteristic is a first media type, and the second characteristic is a second media type different from the first media type. For example, the virtual objects 110a, 110b, and 110c may represent video files, and the virtual objects 110d, 110e, and 110f may represent audio files. In some implementations, as represented by block 410i, the first characteristic is an association with a first application, and the second characteristic is an association with a second application different from the first application. For example, the virtual objects 110g, 110h, and 110i may represent content that is associated with a game application, and the virtual objects 110j, 110k, and 110l may represent content that is associated with a productivity application.

In various implementations, as represented by block 420, the method 400 includes obtaining a user input that corresponds to a request to change to a second viewing arrangement in a second region of the XR environment. As represented by block 420a, the user input may include a gesture input. For example, the user input may include an image that is received from an image sensor. The image may be a still image or a video feed comprising a plurality of video frames. The image includes pixels that may represent various objects, including, for example, an extremity of the user. For example, the electronic device 102 shown in FIGS. 1A-1D may perform image analysis to detect a gesture performed by the user, e.g., a gesture directed to one or more of the virtual objects or to a region in the XR environment.

In some implementations, as represented by block 420b, the user input includes an audio input. The audio input may be received from an audio sensor, such as a microphone. For example, the user may provide a spoken command to change to the second viewing arrangement.

In some implementations, as represented by block 420c, the method 400 includes receiving the user input from a user input device. For example, the user input may be received from a keyboard, mouse, stylus, and/or touch-sensitive display. As another example, a user-facing image sensor may provide data that may be used to determine a gaze vector. For example, the electronic device 102 shown in FIGS. 1A-1D may determine that a gaze of the user is directed to one or more of the virtual objects or to a region in the XR environment.

In some implementations, as represented by block 420d, the method 400 includes obtaining a confirmation input before determining the mapping between the first spatial arrangement and a second spatial arrangement. For example, the electronic device 102 shown in FIGS. 1A-1D may use an accelerometer, gyroscope, and/or inertial measurement unit (IMU) to sense a head pose of the user. An image sensor may be used to detect a gesture performed by the user. In some implementations, the confirmation input comprises a gaze vector that is maintained for at least a threshold duration.

In some implementations, as represented by block 420e, the second viewing arrangement comprises an unbounded viewing arrangement. For example, the virtual objects may be displayed in a second region of the XR environment that may not be defined by a boundary. In some implementations, as represented by block 420f, the second region of the XR environment is associated with a physical element in the XR environment. For example, the second region may be associated with a physical table that is present in the XR environment. In some implementations, as represented by block 420g, the second region of the XR environment is associated with a surface of the physical element in the XR environment. For example, the second region may be associated with a tabletop of a physical table that is present in the XR environment.

In various implementations, as represented by block 430, the method 400 includes determining a mapping between the first spatial arrangement and a second spatial arrangement based on spatial relationships between the set of virtual objects. For example, virtual objects that share a first spatial characteristic may be grouped together. The virtual objects sharing the first spatial characteristic may be grouped separately from virtual objects that share a second spatial characteristic that is different from the first spatial characteristic. Automatically arranging the virtual objects in the second viewing arrangement reduces a need for user inputs corresponding to the user manually arranging the virtual objects in the second viewing arrangement. Reducing unnecessary user inputs reduces utilization of computing resources associated with interpreting and acting upon unnecessary user inputs, thereby enhancing operability of the device by reducing power consumption and/or heat generation by the device.

Referring to FIG. 4C, in some implementations, as represented by block 430a, a display size of a virtual object is determined as a function of a size of a physical element. For example, a virtual object may be resized to satisfy aesthetic criteria, e.g., proportionality to a physical element in proximity to which the virtual object is displayed. As another example, the virtual object may be sized so that it fits on a surface of the physical element, e.g., with other virtual objects with which it is displayed.

As represented by block 430b, in some implementations, the method 400 includes determining a subset of virtual objects that have a first characteristic and displaying the subset of virtual objects as a cluster of virtual objects in the second spatial arrangement. For example, as represented by block 430c, the first characteristic may be a first media type. As another example, as represented by block 430d, the first characteristic may be an association with a first application. Virtual objects that represent content of the same media type or content that is associated with the same application may be clustered together in the second spatial arrangement.

As represented by block 430e, the first characteristic may be a spatial relationship in the first spatial arrangement. For example, virtual objects that are associated with a first two-dimensional virtual surface in the first viewing arrangement may be displayed in a first cluster in the second viewing arrangement. Such virtual objects may be grouped separately from virtual objects that share a second characteristic. For example, virtual objects that are associated with a second two-dimensional virtual surface in the first viewing arrangement may be displayed in a second cluster in the second viewing arrangement. The distance between the first and second clusters may be determined based on, for example, the spatial relationship between the first and second two-dimensional virtual surfaces in the first viewing arrangement.

In some implementations, as represented by block 430f, the spatial relationship is a distance from a point on the first region that satisfies a threshold. For example, some virtual objects may be within a threshold radius of a point (e.g., point P1 of FIG. 1A). Such virtual objects may be displayed as a cluster in the second viewing arrangement.

In some implementations, as represented by block 430g, the first characteristic is an association with a physical element. For example, virtual objects that are associated with a physical table that is present in the XR environment may be displayed as a cluster.

In various implementations, as represented by block 440, the method 400 includes displaying the set of virtual objects in the second viewing arrangement in the second region of the XR environment that is unbounded (e.g., not surrounded by and/or not enclosed within a visible boundary). Spatial relationships between the virtual objects may be preserved or changed. For example, the electronic device 102 shown in FIGS. 1A-1D may preserve the spatial relationships between the virtual objects to the extent possible while still displaying the virtual objects in the second region. In some implementations, the electronic device 102 arranges virtual objects to satisfy aesthetic criteria. For example, the electronic device 102 may arrange the virtual objects by shape and/or size. As another example, if the second region is associated with a physical element, the electronic device 102 may arrange the virtual objects based on the shape of the physical element. Automatically arranging the virtual objects in the second viewing arrangement reduces a need for user inputs corresponding to the user manually arranging the virtual objects in the second viewing arrangement. Reducing unnecessary user inputs reduces utilization of computing resources associated with interpreting and acting upon unnecessary user inputs, thereby enhancing operability of the device by reducing power consumption and/or heat generation by the device.

In some implementations, the electronic device 102 resizes virtual objects to accommodate display constraints. For example, if the second region is associated with a physical element, the object renderer 310 may resize virtual objects to fit the physical element. In some implementations, the object renderer 310 resizes virtual objects to satisfy aesthetic criteria. For example, certain virtual objects may be resized to maintain proportionality with other virtual objects or with other features of the XR environment.

Virtual objects can be manipulated (e.g., moved) in the XR environment. In some implementations, as represented by block 440a, the method 400 includes obtaining an untethered user input that corresponds to a user selection of a particular virtual object. For example, the electronic device 102 shown in FIGS. 1A-1D may detect a gesture input. In some implementations, as represented by block 440b, a confirmation input is obtained. The confirmation input corresponds to a confirmation of the user selection of the particular virtual object. For example, the electronic device 102 may use an accelerometer, gyroscope, and/or inertial measurement unit (IMU) to sense a head pose of the user. An image sensor may be used to detect a gesture performed by the user. In some implementations, the confirmation input comprises a gaze vector that is maintained for at least a threshold duration.

In some implementations, as represented by block 440c, the method 400 includes obtaining a manipulation user input. The manipulation user input corresponds to a manipulation, e.g., a movement, of the virtual object that the user intends to be displayed. In some implementations, as represented by block 440d, the manipulation user input includes a gesture input. As represented by block 440e, in some implementations, the method 400 includes displaying a manipulation of the particular virtual object in the XR environment based on the manipulation user input. For example, the user may perform a drag and drop gesture in connection with a selected virtual object. The electronic device 102 shown in FIGS. 1A-1D may display a movement of the selected virtual object from one area of the XR environment to another area in accordance with the gesture.

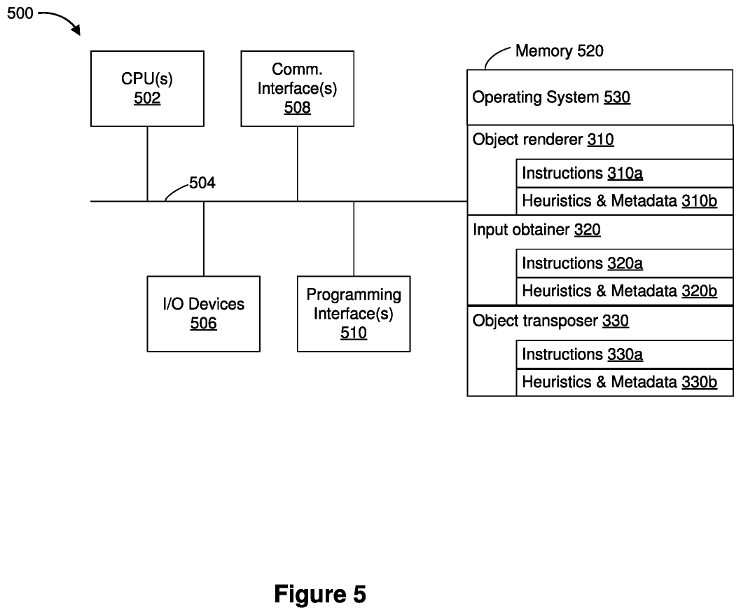

FIG. 5 is a block diagram of a device 500 enabled with one or more components of a device (e.g., the electronic device 102 shown in FIGS. 1A-1D) in accordance with some implementations. While certain specific features are illustrated, those of ordinary skill in the art will appreciate from the present disclosure that various other features have not been illustrated for the sake of brevity, and so as not to obscure more pertinent aspects of the implementations disclosed herein. To that end, as a non-limiting example, in some implementations the device 500 includes one or more processing units (CPUs) 502, one or more input/output (I/O) devices 506, one or more communication interface(s) 508, one or more programming interface(s) 510, a memory 520, and one or more communication buses 504 for interconnecting these and various other components.

In some implementations, the communication interface 508 is provided to, among other uses, establish, and maintain a metadata tunnel between a cloud-hosted network management system and at least one private network including one or more compliant devices. In some implementations, the one or more communication buses 504 include circuitry that interconnects and controls communications between system components. The memory 520 includes high-speed random access memory, such as DRAM, SRAM, DDR RAM or other random access solid state memory devices, and may include non-volatile memory, such as one or more magnetic disk storage devices, optical disk storage devices, flash memory devices, or other non-volatile solid state storage devices. The memory 520 optionally includes one or more storage devices remotely located from the one or more CPUs 502. The memory 520 comprises a non-transitory computer readable storage medium.

In some implementations, the memory 520 or the non-transitory computer readable storage medium of the memory 520 stores the following programs, modules and data structures, or a subset thereof including an optional operating system 530, the object renderer 310, the input obtainer 320, and the object transposer 330. As described herein, the object renderer 310 may include instructions 310a and/or heuristics and metadata 310b for displaying a set of virtual objects in a viewing arrangement on a display in an XR environment. As described herein, the input obtainer 320 may include instructions 320a and/or heuristics and metadata 320b for obtaining a user input that corresponds to a change to a second viewing arrangement. As described herein, the object transposer 330 may include instructions 330a and/or heuristics and metadata 330b for determining a mapping between a first spatial arrangement and a second spatial arrangement based on spatial relationships between the virtual objects.

It will be appreciated that FIG. 5 is intended as a functional description of the various features which may be present in a particular implementation as opposed to a structural schematic of the implementations described herein. As recognized by those of ordinary skill in the art, items shown separately could be combined and some items could be separated. For example, some functional blocks shown separately in FIG. 5 could be implemented as a single block, and the various functions of single functional blocks could be implemented by one or more functional blocks in various implementations. The actual number of blocks and the division of particular functions and how features are allocated among them will vary from one implementation to another and, in some implementations, depends in part on the particular combination of hardware, software, and/or firmware chosen for a particular implementation.

While various aspects of implementations within the scope of the appended claims are described above, it should be apparent that the various features of implementations described above may be embodied in a wide variety of forms and that any specific structure and/or function described above is merely illustrative. Based on the present disclosure one skilled in the art should appreciate that an aspect described herein may be implemented independently of any other aspects and that two or more of these aspects may be combined in various ways. For example, an apparatus may be implemented and/or a method may be practiced using any number of the aspects set forth herein. In addition, such an apparatus may be implemented and/or such a method may be practiced using other structure and/or functionality in addition to or other than one or more of the aspects set forth herein.

It will also be understood that, although the terms “first,” “second,” etc. may be used herein to describe various elements, these elements should not be limited by these terms. These terms are only used to distinguish one element from another.

The terminology used herein is for the purpose of describing particular implementations only and is not intended to be limiting of the claims. As used in the description of the implementations and the appended claims, the singular forms “a,” “an,” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

As used herein, the term “if” may be construed to mean “when” or “upon” or “in response to determining” or “in accordance with a determination” or “in response to detecting,” that a stated condition precedent is true, depending on the context. Similarly, the phrase “if it is determined [that a stated condition precedent is true]” or “if [a stated condition precedent is true]” or “when [a stated condition precedent is true]” may be construed to mean “upon determining” or “in response to determining” or “in accordance with a determination” or “upon detecting” or “in response to detecting” that the stated condition precedent is true, depending on the context.

What is claimed is:

1. A method comprising:
at a device including a display, one or more processors, and a non-transitory memory:
displaying a set of virtual objects in a first viewing arrangement in a first region of an environment that is bounded, wherein the set of virtual objects are arranged in a first spatial arrangement;
obtaining a user input corresponding to a request to change to a second viewing arrangement in a second region of the environment that is unbounded;
determining a mapping between the first spatial arrangement and a second spatial arrangement based on spatial relationships between the set of virtual objects; and
displaying the set of virtual objects in the second viewing arrangement in the second region of the environment.

2. The method of claim 1, wherein the first viewing arrangement comprises a bounded viewing arrangement.

3. The method of claim 1, wherein the first region of the environment comprises a first two-dimensional virtual surface enclosed by a boundary.

4. The method of claim 3, wherein the first region of the environment further comprises a second two-dimensional virtual surface substantially parallel to the first two-dimensional virtual surface.

5. The method of claim 4, further comprising displaying the set of virtual objects on at least one of the first two-dimensional virtual surface or the second two-dimensional virtual surface.

6. The method of claim 2, wherein the set of virtual objects correspond to content items having a first characteristic.

7. The method of claim 2, wherein the set of virtual objects comprises:
a first subset of virtual objects corresponding to content items having a first characteristic; and
a second subset of virtual objects corresponding to content items having a second characteristic different from the first characteristic.

8. The method of claim 7, further comprising:
displaying the first subset of virtual objects in a first area of the first region; and
displaying the second subset of virtual objects in a second area of the first region.

9. The method of claim 7, wherein:
the first characteristic is a first media type; and
the second characteristic is a second media type different from the first media type.

10. The method of claim 7, wherein:
the first characteristic is an association with a first application; and
the second characteristic is an association with a second application different from the first application.

11. The method of claim 1, wherein the user input comprises a gesture input.

12. The method of claim 1, wherein the user input comprises an audio input.

13. The method of claim 1, further comprising receiving the user input from a user input device.

14. The method of claim 1, further comprising obtaining a confirmation input before determining the mapping between the first spatial arrangement and the second spatial arrangement.

15. The method of claim 1, wherein the second viewing arrangement comprises an unbounded viewing arrangement.

16. The method of claim 1, wherein the second region of the environment is associated with a physical element in the environment.

17. The method of claim 16, wherein the second region of the environment is associated with a surface of the physical element in the environment.

18. The method of claim 16, further comprising determining a display size of a virtual object as a function of a size of the physical element.

19. A device comprising:
one or more processors;
a non-transitory memory; and
one or more programs stored in the non-transitory memory, which, when executed by the one or more processors, cause the device to:
display a set of virtual objects in a first viewing arrangement in a first region of an environment that is bounded, wherein the set of virtual objects are arranged in a first spatial arrangement;
obtain a user input corresponding to a request to change to a second viewing arrangement in a second region of the environment that is unbounded;
determine a mapping between the first spatial arrangement and a second spatial arrangement based on spatial relationships between the set of virtual objects; and
display the set of virtual objects in the second viewing arrangement in the second region of the environment.

20. A non-transitory memory storing one or more programs, which, when executed by one or more processors of a device, cause the device to:
display a set of virtual objects in a first viewing arrangement in a first region of an environment that is bounded, wherein the set of virtual objects are arranged in a first spatial arrangement;
obtain a user input corresponding to a request to change to a second viewing arrangement in a second region of the environment that is unbounded;
determine a mapping between the first spatial arrangement and a second spatial arrangement based on spatial relationships between the set of virtual objects; and
display the set of virtual objects in the second viewing arrangement in the second region of the environment.
